(19) United States
(12) Patent Application Publication
(10) Pub. No.: US 2013/0149951 A1
(43) Pub. Date: Jun. 13, 2013

(54) AIR DISCHARGE SYSTEM OF HVAC SYSTEM FOR VEHICLE

(71) Applicants: Jun Kyu Park, Hwaseong-si (KR); Hyun Kim, Hwaseong-si (KR); Hee Sang Park, Hwaseong-si (KR); Tae Han Kim, Seoul (KR); Sung Beom Song, Hwaseong-si (KR); Moo Yong Kim, Suwon-si (KR); Hee Jun Jeong, Hwaseong-si (KR)

(72) Inventors: Jun Kyu Park, Hwaseong-si (KR); Hyun Kim, Hwaseong-si (KR); Hee Sang Park, Hwaseong-si (KR); Tae Han Kim, Seoul (KR); Sung Beom Song, Hwaseong-si (KR); Moo Yong Kim, Suwon-si (KR); Hee Jun Jeong, Hwaseong-si (KR)

(73) Assignees: Kia Motors Corp., Seoul (KR); Hyundai Motor Company, Seoul (KR)

(21) Appl. No.: 13/528,341

(22) Filed: Jun. 20, 2012

(30) Foreign Application Priority Data
Dec. 8, 2011 (KR) 10-2011-0130983

(51) Int. Cl. B60H 1/26

(52) U.S. Cl. 454/145; 454/156; 165/42

(57) ABSTRACT

An air discharge system of an HVAC (Heat, Ventilation, and Air Conditioning) system for a vehicle, may include a first path provided in the HVAC system to communicate with discharge ports of a front seat, the first path allowing air that has passed through a heat exchanger to be discharged through the discharge ports of the front seat, a second path diverged from the first path to communicate with discharge ports of a rear seat, the second path allowing air that has passed through the heat exchanger to be discharged through the discharge ports of the rear seat, thus enabling the independent discharge of air to the rear seat, and a first control door provided at a position where the first path and the second path diverge from each other, thus opening or closing the second path.

### CROSS-REFERENCE TO RELATED APPLICATIONS

The present application claims priority to Korean Patent Application No. 10-2011-0130983 filed on Dec. 8, 2011, the entire contents of which is incorporated herein for purposes by this reference.

### BACKGROUND OF THE INVENTION

1. Field of the Invention

The present invention relates to an air discharge system of an HVAC (Heat, Ventilation, and Air Conditioning) system for a vehicle, intended to divide an air discharge path into a front-seat air path and a rear-seat air path, thus improving and maintaining HVAC performance in a rear seat regardless of a change in mode of the HVAC system in a front seat, and enabling a temperature and an air direction of the HVAC system in the rear seat to be independently controlled.

2. Description of Related Art

Generally, an HVAC system is a mechanical system that is used for cooling, heating, dehumidification, humidification, and air purification. The HVAC system installed in a vehicle is provided with a heat exchanger to achieve the cooling, heating, ventilation or air conditioning in a vehicle compartment.

That is, in order to heat air in the vehicle compartment in winter, the temperature of the air is increased by a heater system, and the air having the increased temperature may be discharged through a duct to a front seat and a rear seat, respectively, as shown in FIG. 1.

In this case, the air discharged to the front seat and the rear seat passes through a heat exchanger 2 of the HVAC system 1. As shown in FIG. 2, the discharge of the air to the rear seat is performed while an air path for the rear seat is separated from an air path for the front seat.

However, the air discharged through the heat exchanger is reduced in temperature and air discharge volume while passing through the duct, so that HVAC performance in the rear seat is undesirably deteriorated.

Thus, in order to improve the HVAC performance in the rear seat of the vehicle, four methods have been proposed, namely, a method of increasing a capacity of the heat exchanger, a method of providing a heat exchanger to the rear seat independently from the front seat, thus decreasing reduction in temperature and volume of air discharged to the rear seat through the duct, a method of raising a blowing air temperature to increase the temperature of the front and rear seats, a method of providing a blower independently from the front seat to increase the volume of air discharged to the rear seat through the duct.

However, the first method is problematic in that an increase in capacity of the heat exchanger leads to an increase in that of a heat exchange system. The second method is problematic in that the utilization of the internal space of a console is deteriorated because of the additional heat exchanger. The third method is problematic in that an air volume for the front seat is also increased to increase an air volume for the rear seat, thus generating noise. The fourth method is problematic in that the additional blower is provided in the console, so that space utilization is deteriorated, and vibration and noise are generated by the operation of the blower.

In addition, the related art is problematic in that an air path for a foot area of the front seat and an air path for a floor area of the rear seat are not separated from each other as shown in FIG. 2, so that heating air is identically discharged to the front seat and the rear seat. Thus it is impossible to satisfy the requirements (independent control of air direction and temperature) of a passenger in the rear seat for HVAC performance.

That is, when an additional door is provided between the air path for the foot area of the front seat and the air path for the floor area of the rear seat, the discharged air is divided into portions, so that it is possible to close the air path for the floor area of the rear seat. However, it is impossible to form the air path for the floor area of the rear seat independently from the air path for the foot area of the front seat.

For example, as shown in FIG. 3, when a passenger in the front seat switches a mode to a face mode or a defog (DEF) mode discharging air to a windshield area, the air path for the floor area of the rear seat is closed along with that for the foot area of the front seat, so that a passenger in the rear seat may not control an air direction of the rear seat independently from a front seat control.

Meanwhile, as shown in FIG. 4, a structure for discharging air through the interior of the console box to the rear seat can control an air direction independently from a front seat control, unlike the foot area of the front seat and the floor area of the rear seat.

However, in the case of switching the mode to the face mode or the defog mode in the front seat, if the passenger in the rear seat switches the mode to the cooling or heating mode, air is insufficient to increase the temperature of the foot area of the front seat for the cooling or heating performance because the air is discharged through the console box.

Further, if an additional control button is provided on the rear seat to control an air direction, air may be discharged through the console box in the defog mode, but the air is not discharged to the floor area of the rear seat as described above.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an air discharge system of an HVAC system for a vehicle, intended to divide an air discharge path into a front-seat air path and a rear-seat air path, thus improving and maintaining HVAC performance in a rear seat regardless of a change in mode of the HVAC system in a front seat, and enabling a temperature and an air direction of the HVAC system in the rear seat to be independently controlled.

In an aspect of the present invention, an air discharge system of an HVAC (Heat, Ventilation, and Air Conditioning) system for a vehicle, may include a first path provided in the HVAC system to communicate with discharge ports of a front seat, the first path allowing air that may have passed through a heat exchanger to be discharged through the discharge ports of the front seat, a second path diverged from the first path to communicate with discharge ports of a rear seat, the second path allowing air that may have passed through the heat exchanger to be discharged through the discharge ports of the rear seat, thus enabling the independent discharge of air to the rear seat, and a first control door provided at a position where the first path and the second path diverge from each other, thus opening or closing the second path.

The second path is diverged from the first path between the heat exchanger and the first control door.

The second path may include a third path discharging air through an interior of a console box toward the rear seat, and a fourth path discharging air toward a bottom surface of the rear seat, with a rear floor discharge port provided at an end of the fourth path.

The air discharge system may further include an air duct provided at one end of the third path, and having on the other end thereof a plurality of air discharge ports, and a second control door provided in the air duct to control a volume and a direction of air discharged from the air duct to the one end and the other end of the third path.

The air discharge ports may include a rear face discharge port formed toward an upper portion of the rear seat, and a rear foot discharge port formed toward a side of the rear seat, wherein the second control door is disposed between the rear face discharge port and the rear foot discharge port.

The rear foot discharge port may include rear foot discharge ports that are provided on both sides to be opposite to each other.

The present invention is advantageous in that a first path for discharging air to a front seat is separated from a second path for discharging air to a rear seat, thus independently performing the discharge of air to the rear seat and a control thereof, regardless of the HVAC mode of the front seat.

Further, the present invention is advantageous in that air treated by a heat exchange process is discharged to a front seat and a rear seat, respectively, while a first path and a second path are separately formed, thus providing the same HVAC performance to the front seat and the rear seat.

Furthermore, the present invention is advantageous in that air discharged to a rear seat is naturally discharged in several directions through a console box, and an air discharge volume is increased via a rear floor discharge port, thus improving performance of heating or cooling the rear seat.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating a conventional HVAC system.

FIG. 2 is a view illustrating an operation of discharging air to a front seat and a rear seat in the conventional HVAC system.

FIG. 3 is a view illustrating a state in which it is impossible to discharge air to a foot area of the front seat and a floor area of the rear seat in a defog mode in the conventional HVAC system.

FIG. 4 is a view illustrating a state in which air is dispersed and discharged to a console area of the rear seat in the defog mode in the conventional HVAC system.

FIG. 5 is a view illustrating an air discharge system of a HVAC system according to an exemplary embodiment of the present invention.

FIG. 6 is a view illustrating an example wherein air is discharged to a front seat and a rear seat through the air discharge system of the present invention.

FIG. 7 is a view illustrating an air duct and a second control door in the HVAC system according to an exemplary embodiment of the present invention.

FIG. 8 is a view illustrating an air discharge flow in the air duct according to an exemplary embodiment of the present invention.

FIGS. 9 and 10 are views illustrating an example of discharging air to the front seat and the rear seat through the air discharge system according to an exemplary embodiment of the present invention.

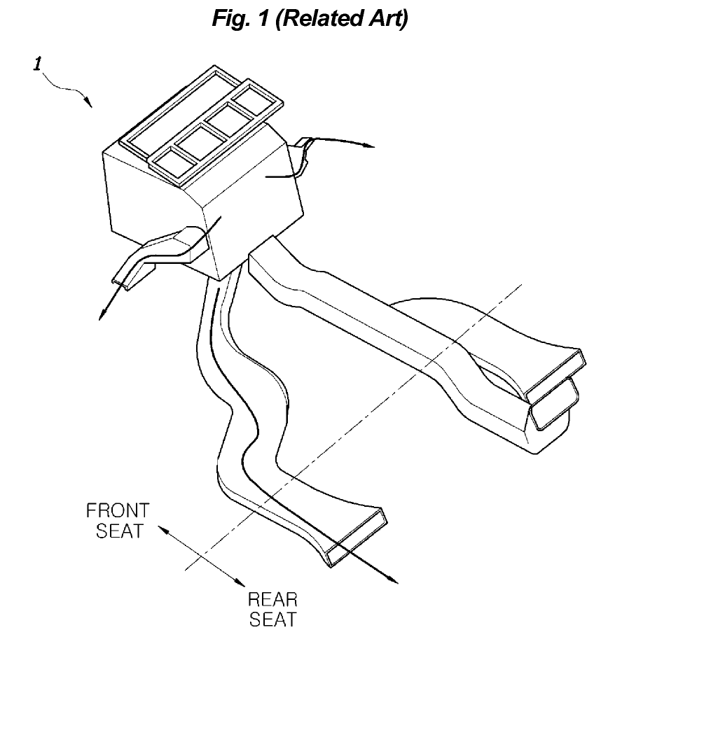

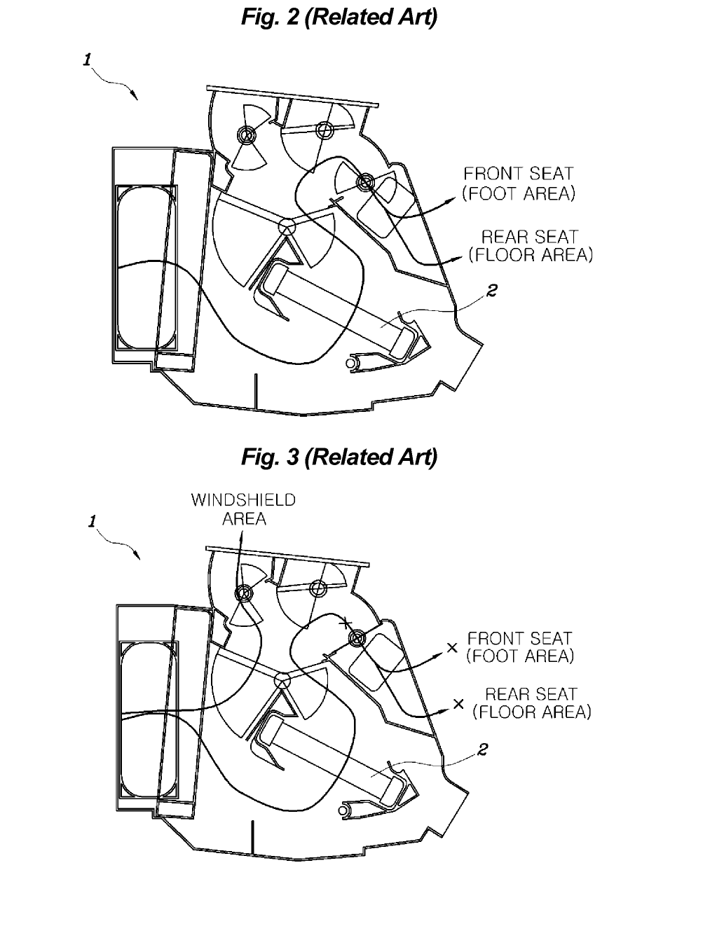

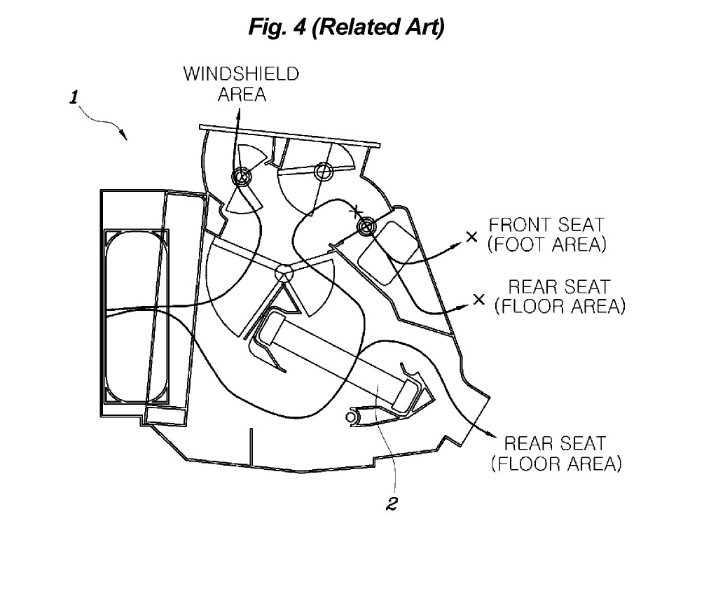

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will be described in detail with reference to the accompanying drawings.

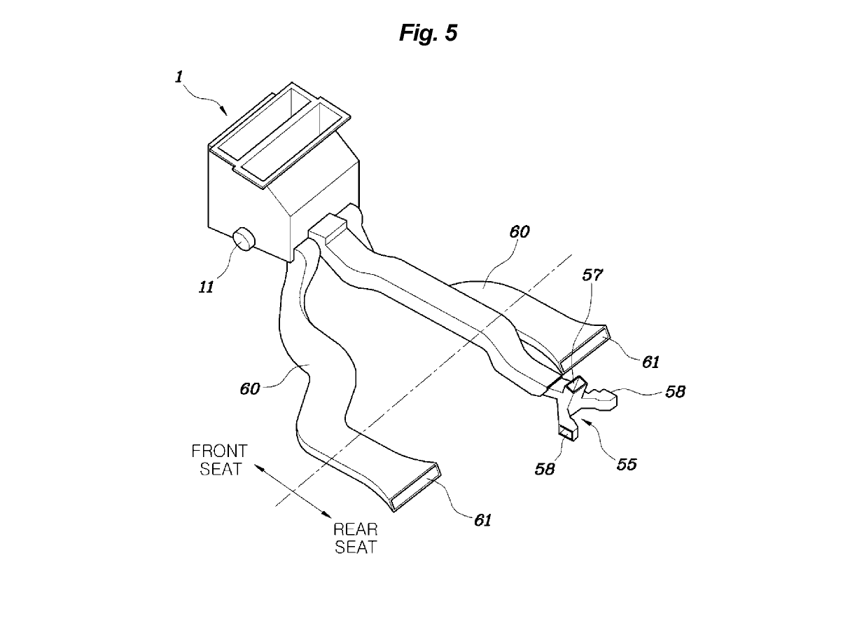

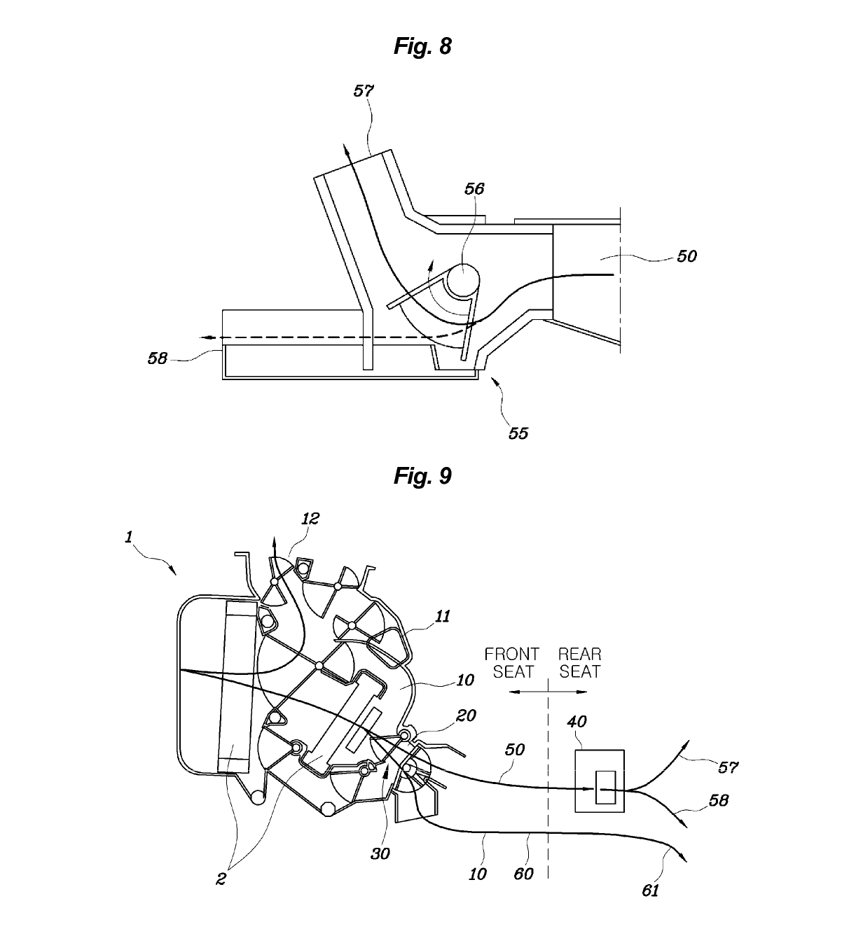

Referring to FIGS. 5 to 10, an air discharge system of a HVAC system for a vehicle according to an exemplary embodiment of the present invention includes a first path 10, a second path 20, and a first control door 30. The first path 10 is provided in the HVAC system 1 to communicate with discharge ports of a front seat, and allows air that has passed through a heat exchanger 2 to be discharged through the discharge ports of the front seat. The second path 20 is formed separately from the first path 10 to communicate with discharge ports of a rear seat, and allows air that has passed through the heat exchanger 2 to be discharged through the discharge ports of the rear seat, thus enabling the independent discharge of air to the rear seat. The first control door 30 is provided at a position where the first path 10 and the second path 20 diverge from each other, thus opening or closing the second path 20.

That is, the first path 10 for discharging air to the front seat is separated from the second path 20 for discharging air to the rear seat, thus independently controlling the direction and temperature of air of the HVAC system 1 in the rear seat, regardless of a change in mode of the HVAC system (HVAC switch) in the front seat.

Further, air going through a heat exchange process while passing through the heat exchanger 2 is discharged through the first path 10 and the second path 20 to the front seat and the rear seat, respectively, thus providing the same HVAC performance to the front seat and the rear seat.

Here, a heater core and an evaporator core are provided, as the heat exchanger 2, in the HVAC system 1. Several doors are provided in the HVAC system 1 so that air goes through the heat exchange process while suitably passing through the heater core and the evaporator core depending on a heating or cooling mode or a set temperature.

In an exemplary embodiment of the present invention, the second path 20 includes a third path 50 that discharges air through an interior of a console box 40 toward the rear seat, and a fourth path 60 that discharges air toward a bottom surface of the rear seat, with a rear floor discharge port 61 provided at an end of the fourth path 60.

That is, the second path 20 for discharging air to the rear seat includes the third path 50 and the fourth path 60, thus jointly controlling air discharged from the console box 40 to the rear seat and air discharged from a vehicle floor to the rear seat.

According to an exemplary embodiment of the present invention, the air discharge system includes an air duct 55 and a second control door 56. The air duct 55 is provided at one end of the third path 50, and has on the other end thereof a plurality of air discharge ports. The second control door 56 is provided in the air duct 55 to control the volume and direction of air discharged from the air duct 55.

That is, the air duct 55 is provided with the plurality of discharge ports to discharge air from the air duct 55 to the rear seat in several directions, thus increasing an air discharge volume. Further, the second control door 56 is rotatably provided in the air duct 55, thus discharging air while controlling an air volume for each discharge port.

According to an exemplary embodiment of the present invention, the discharge ports may include a rear face discharge port 57 that is formed toward an upper portion of the rear seat, and a rear foot discharge port 58 that is formed toward a side of the rear seat.

That is, the rear face discharge port 57 is obliquely formed upwards to face the face of a passenger, and the rear foot discharge port 58 is formed toward the leg of the passenger, thus properly controlling an air direction depending on a direction of the passenger in the rear seat and a temperature control, therefore keeping the air in the rear seat pleasant.

According to an exemplary embodiment of the present invention, the rear foot discharge port 58 may include rear foot discharge ports that are provided on both sides to be opposite to each other. That is, the rear foot discharge ports 58 are provided on both sides of the console box 40, thus allowing air going through the heat exchange process to be uniformly supplied to the bottom of the rear seat.

The operation and effect of the present invention will be described in detail.

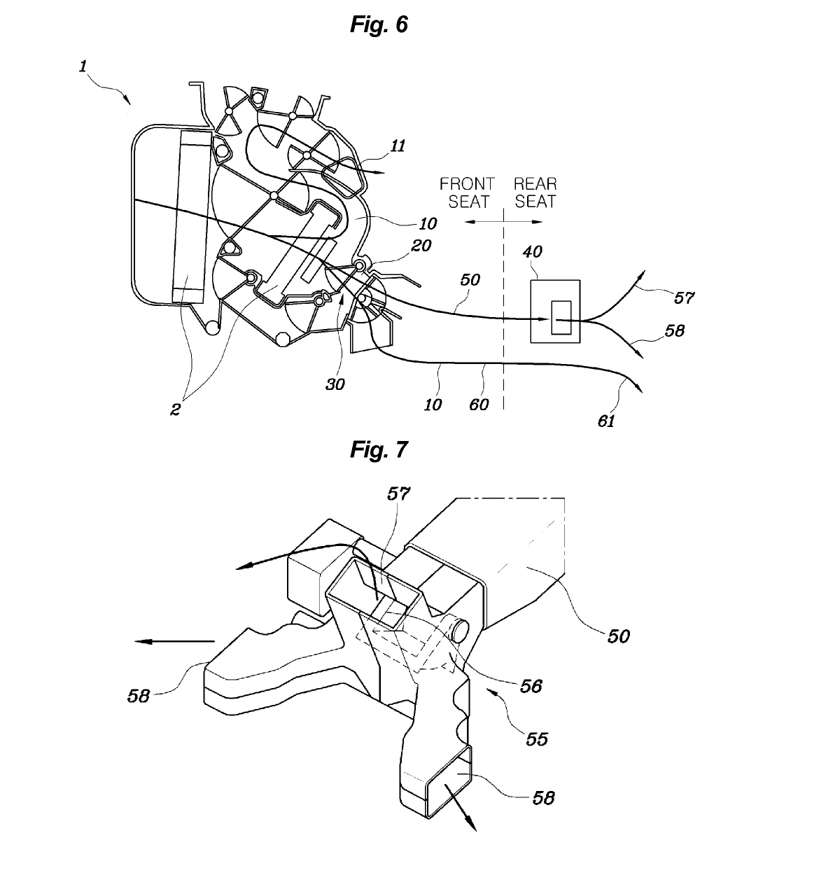

In the HVAC system 1 mounted to the vehicle, when the HVAC switch of the front seat is driven in the foot mode, and the HVAC switch of the rear seat is driven in the opening mode, as shown in FIG. 6, air going through the heat exchange process through the heat exchanger 2 is discharged through the first path 10 to the front foot discharge port 11 of the front seat, and is discharged to the foot area of the front seat.

Further, air that has gone through the heat exchange process through the heat exchanger 2 is discharged through the second path 20 to the third path 50 and the fourth path 60. Air discharged through the third path 50 is discharged through the air duct 55 to the rear foot discharge port 58 and the rear face discharge port 57, as a result of which the air is discharged to the foot area and the face area of the rear seat. Here, the air discharged to the foot area and the face area of the rear seat is controlled in its direction by the second control door 56 when it is discharged.

Further, the air discharged through the fourth path 60 is discharged to the rear floor discharge port 61.

Thus, the air that has gone through the heat exchange process while passing through the heat exchanger 2 is discharged through the first path 10 and the second path 20 to the front seat and the rear seat, respectively, thus providing the same HVAC performance to the front seat and the rear seat.

Meanwhile, when the HVAC switch of the front seat is driven in the defog mode and the HVAC switch of the rear seat is driven in the opening mode, the air that has gone through the heat exchange process as shown in FIG. 9 is discharged through the first path 10 to the windshield discharge port 12 of the front seat, so that the air is discharged to the windshield of the front seat.

Further, air discharged through the second path 20 to the third path 50 and the fourth path 60 is discharged to the rear seat, and a detailed discharge operation has been described above with reference to FIG. 6.

Thus, the first path 10 discharged to the front seat and the second path 20 discharged to the rear seat are separated from each other, thus allowing air to be discharged to the rear seat regardless of the HVAC mode of the front seat and enabling the direction and the temperature of air in the rear seat to be independently controlled.

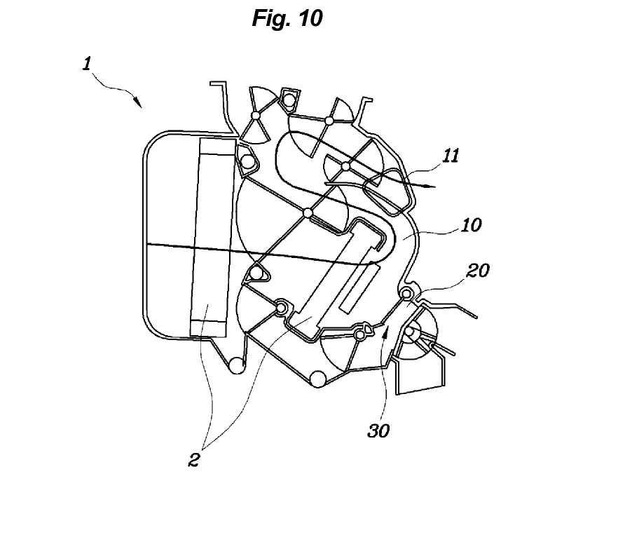

Meanwhile, when the HVAC switch of the front seat is driven in the foot mode and the HVAC switch of the rear seat is driven in the closing mode, the air that has gone through the heat exchange process through the heat exchanger 2 as shown in FIG. 10 is discharged through the first path 10 to the front foot discharge port 11 of the front seat, so that the air is discharged to the foot area of the front seat.

However, since the HVAC switch of the rear seat is in the closing mode, the first control door 30 closes the second path 20, so that the air is not discharged to the rear seat.

As described above, the present invention provides an air discharge system of a HVAC system, in which a first path for discharging air to a front seat is separated from a second path for discharging air to a rear seat, thus independently performing the discharge of air to the rear seat and a control thereof, regardless of the HVAC mode of the front seat, and air treated by a heat exchange process is discharged to the front seat and the rear seat, respectively, through the first and second paths that are separately formed, thus providing the same HVAC performance to the front seat and the rear seat.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air discharge system of an HVAC (Heat, Ventilation, and Air Conditioning) system for a vehicle, comprising:
a first path provided in the HVAC system to communicate with discharge ports of a front seat, the first path allowing air that has passed through a heat exchanger to be discharged through the discharge ports of the front seat;
a second path diverged from the first path to communicate with discharge ports of a rear seat, the second path allowing air that has passed through the heat exchanger to be discharged through the discharge ports of the rear seat, thus enabling the independent discharge of air to the rear seat; and
a first control door provided at a position where the first path and the second path diverge from each other, thus opening or closing the second path.

2. The air discharge system as set forth in claim 1, wherein the second path is diverged from the first path between the heat exchanger and the first control door.

3. The air discharge system as set forth in claim 1, wherein the second path includes:
a third path discharging air through an interior of a console box toward the rear seat; and
a fourth path discharging air toward a bottom surface of the rear seat, with a rear floor discharge port provided at an end of the fourth path.

4. The air discharge system as set forth in claim 3, further including:
an air duct provided at one end of the third path, and having on the other end thereof a plurality of air discharge ports; and
a second control door provided in the air duct to control a volume and a direction of air discharged from the air duct to the one end and the other end of the third path.

5. The air discharge system as set forth in claim 4, wherein the air discharge ports include:
a rear face discharge port formed toward an upper portion of the rear seat; and
a rear foot discharge port formed toward a side of the rear seat,
wherein the second control door is disposed between the rear face discharge port and the rear foot discharge port.

6. The air discharge system as set forth in claim 5, wherein the rear foot discharge port includes rear foot discharge ports that are provided on both sides to be opposite to each other.
